(19) United States
(12) Patent Application Publication
(10) Pub. No.: US 2014/0324354 A1
(43) Pub. Date: Oct. 30, 2014

(54) TRANSMISSION COEFFICIENT METHOD FOR AVO SEISMIC ANALYSIS

(71) Applicant: KING FAHD UNIVERSITY OF PETROLEUM AND MINERALS, Dhahran (SA)

(72) Inventors: ABDULLATIF ABDULRAHMAN SHUHAIL AL-SHUHAIL, DHAHRAN (SA); AFEEZ KOLA POPOOLA, AL-THOQBAH (SA)

(73) Assignee: KING FAHD UNIVERSITY OF PETROLEUM AND MINERALS, DHAHRAN (SA)

(21) Appl. No.: 13/873,118

(22) Filed: Apr. 29, 2013

(51) Int. Cl. G01V 1/30

(52) U.S. Cl. CPC G01V 1/307
USPC 702/14

(57) ABSTRACT

The transmission coefficient method for AVO (amplitude variation with offset) seismic analysis computes incident-to-transmitted pressure wave and incident-to-transmitted shear wave data in a manner that is compatible with existing AVO applications for analysis on the transmission coefficients of VSP data. Amplitude variation with offset (AVO) computation techniques known in the art provide estimates of pressure wave, shear wave and pseudo-Poisson's reflectivity. Such estimates are based on the Aki-Richards approximation of Zoeppritz's formulation of reflection amplitude and polarity variation with respect to incidence angle. The Zoeppritz equations describe the amplitudes of body waves when incident on an interface, resulting in a scattering matrix in which all possible incident and generated modes are addressed. The present method further simplifies the Aki and Richards computations to facilitate further AVO analysis.

### BACKGROUND OF THE INVENTION

1. Field of the Invention

The present invention relates to devices and methods for analysis of seismic data, and particularly to a transmission coefficient method for AVO (amplitude variation with offset) seismic analysis.

2. Description of the Related Art

Seismic exploration is conducted both on land and in water. In both environments, exploration involves surveying subterranean geological formations for hydrocarbon deposits. A survey typically involves deploying acoustic source(s) and acoustic sensors at predetermined locations. The sources impart acoustic waves into the geological formations. Features of the geological formation reflect the acoustic waves to the sensors. The sensors receive the reflected waves, which are detected, conditioned, and processed to generate seismic data. Analysis of the seismic data can then indicate probable locations of the hydrocarbon deposits.

Traditional collection and processing of seismic reflection data begins with the separate generation of conventional pressure waves (P-waves) or shear waves (S-waves), followed by their separate recording on single component receivers, i.e., receivers that have active elements that respond to motions of the reflected waves in only one direction. Assuming a vertically oriented seismic source, conventional P-waves travel down into the earth and are reflected from one (or more) geologic layers as P-waves. A spread of receivers whose active elements respond to vertically oriented elastic wave motion only record the P-waves. Similarly, for shear wave exploration, S-waves produced by a horizontally oriented seismic source are reflected from similar reflectors as S-waves, and are recorded by the spread of receivers in similar fashion, except that the active elements of the receivers would respond to horizontally oriented wave motion exclusively. Multi-component seismic surveys involve measuring several types of waves reflected at the same time. It is, in fact, possible to measure, in addition to the PP waves corresponding to successive reflections of an incident P-wave as a P-wave, the PS waves, which correspond to the incident P-waves reflected as S-waves. More generally, in the case of a seismic source that can generate shear S-waves, it is also possible to record SS waves corresponding to successive reflections of an incident S-wave as an S-wave, and SP waves corresponding to the incident S-waves reflected as P-waves. In a case of high anisotropy due to the presence of faults in the reservoir or above it (referred to as overburden), splitting of the S-waves into a fast S-wave (along the fault lines) and a slow S-wave (orthogonal to the fault lines) can be observed. Then SV and SH waves are discussed. Using the S-waves can therefore be a good way to evaluate the relative anisotropy of the medium. Furthermore, the combination of P- and S-waves allows better detection of anomalies linked with the fluids because S-waves are insensitive to the presence of fluids.

One technique for analyzing the seismic data is called amplitude variation with offset (“AVO”). AVO is a variation in seismic reflection amplitude with change in distance between a source and a receiver that indicates differences in lithology and fluid content in rocks above and below the reflector. AVO analysis is a technique by which geophysicists attempt to determine characteristics of the geological formation, such as thickness, porosity, density, velocity, lithology, and fluid content of rocks. Successful AVO analysis employs certain well-known techniques for processing seismic data and seismic modeling of the seismic data to determine rock properties with a known fluid content. With that knowledge, it is possible to model other types of fluid content.

Seismic modeling is the comparison, simulation or representation of seismic data to define the limits of seismic resolution, assess the ambiguity of interpretation or make predictions. Generation of a synthetic or modeled seismogram from a well log and comparing the synthetic or modeled trace, with seismic data is a common direct modeling procedure. Generating a set of pseudologs, or synthetic data, from seismic data is the process known as seismic inversion, a type of indirect modeling. Models can be developed to address problems of structure and stratigraphy prior to acquisition of seismic data and during the interpretation of the data. One type of inversion is pre-stack waveform inversion (“PSWI”).

The interest shown by exploration seismologists in amplitude-variation-with-offset (“AVO”) analysis for the direct detection of hydrocarbons from seismic data has been growing over the past few years. Reflection records of prestack seismic data contain valuable amplitude information that can be related to the subsurface lithology. With the increasing popularity of AVO, considerable work has also been carried out on AVO inversion, and the fundamental problem of non-uniqueness associated with such an inversion is now well recognized.

An AVO anomaly is most commonly expressed as increasing (rising) AVO in a sedimentary section. This is often where the hydrocarbon reservoir is “softer” (lower acoustic impedance) than the surrounding shales. Typically, amplitude decreases (falls) with offset due to geometrical spreading, attenuation, and other factors. An AVO anomaly can also include examples where amplitude with offset falls at lower rates than the surrounding reflective events.

Amplitude variation with offset (AVO) involves the analysis of the behavior of seismic wave amplitude as a function of the incident angle of the P-wave. Conventional AVO analysis involves the analysis of the amplitudes of reflected signals with incidence angle, and is used in many applications, including fluid detection, lithology typing, and fracture mapping. In conventional surface seismic data, AVO analysis has been applied on the reflected P-wave, Rpp [symbol] , principally for the detection of gas sand. AVO analysis has also been applied in the joint inversion of P-P and P-S seismic data. For vertical seismic profiling (VSP) surveys, AVO has been used also in the analysis of PP and PS reflection coefficients.

The most important application of AVO is the detection of hydrocarbon accumulations. Rising AVO is typically more pronounced in oil-bearing sediments (and more so in gas-bearing sediments). Particularly important examples are those seen in deep water turbidite sands and other major elastic deltas around the world. Most hydrocarbon-filled sedimentary traps are tried to see if they can be visualized and detected with AVO. Almost all major companies use AVO routinely as a tool to “de-risk” exploration targets and to better define the extent and the composition of existing hydrocarbon reservoirs.

The existence of abnormal (rising or falling) amplitude anomalies can sometimes be caused by other factors, such as alternative lithologies and residual hydrocarbons in a breached gas column. Modeling of the petrophysical properties and a good understanding of the sedimentary succession is paramount for successful hydrocarbon detection using AVO. Not all oil and gas fields are associated with an obvious AVO anomaly, and AVO analysis is by no means a failsafe method for gas and oil exploration

Over the years emphasis has been on reflected modes due to an incident P-wave (i.e., RPP and RPS). Classical reflection VSP-AVO has undesirable effects associated with reflected arrivals, e.g., amplitude losses by absorption due to traveling through deeper formations with unknown absorption coefficients; amplitude losses due to reflection at deeper interfaces; wavelet nonstationarity by shifting to lower frequencies due to traveling longer (deeper) distances in the earth, which acts as a low-pass filter; and finally, inaccuracy in modeling due to ray bending by velocity heterogeneities in deeper formations.

Thus, a transmission coefficient method for AVO seismic analysis solving the aforementioned problems is desired.

### SUMMARY OF THE INVENTION

The transmission coefficient method for AVO (amplitude variation with offset) seismic analysis computes incident-to-transmitted pressure wave and incident-to-transmitted shear wave data in a manner that is compatible with existing AVO applications for analysis on the transmission coefficients of vertical seismic profiling (VSP) data. Amplitude variation with offset computation techniques known in the art provide estimates of pressure wave, shear wave and pseudo-Poisson's reflectivity. Such estimates are based on the Aki-Richards approximation of Zoeppritz's formulation of reflection amplitude and polarity variation with respect to incidence angle.

The Zoeppritz equations describe the amplitudes of body waves when incident on an interface resulting in a scattering matrix in which all possible incident and generated modes are addressed. Complexities in the expression of the individual components of the scattering matrix resulted in Aki and Richards expressing these equations in a simplified form, assuming small material contrasts and precritical angles. The present method further simplifies the computation to facilitate further AVO analysis.

These and other features of the present invention will become readily apparent upon further review of the following specification and drawings.

### BRIEF DESCRIPTION OF THE DRAWINGS

FIG. 1 is a diagram showing waves generated at an interface between two elastic media by an incident P-wave.

FIG. 2 is a plot showing a comparison of the approximate T_{PP} (incident-P-to-transmitted-P) with Aki-Richards and the exact Zoeppritz equation vs. the present transmission coefficient method for AVO (amplitude variation with offset) seismic analysis.

FIG. 3 is a plot showing a comparison of the approximate T_{PS} (incident-P-to-transmitted-S) with Aki-Richards and the exact Zoeppritz equation vs. the present transmission coefficient method for AVO (amplitude variation with offset) seismic analysis.

Similar reference characters denote corresponding features consistently throughout the attached drawings.

### DETAILED DESCRIPTION OF THE PREFERRED EMBODIMENTS

At the outset, it should be understood by one of ordinary skill in the art that embodiments of the present method can comprise software or firmware code executing on a computer, a microcontroller, a microprocessor, or a DSP processor; state machines implemented in application specific or programmable logic; or numerous other forms without departing from the spirit and scope of the method described herein. The present method can be provided as a computer program, which includes a non-transitory machine-readable medium having stored thereon instructions that can be used to program a computer (or other electronic devices) to perform a process according to the method. The machine-readable medium can include, but is not limited to, floppy diskettes, optical disks, CD-ROMs, and magneto-optical disks, ROMs, RAMs, EPROMs, EEPROMs, magnetic or optical cards, flash memory, or other type of media or machine-readable medium suitable for storing electronic instructions.

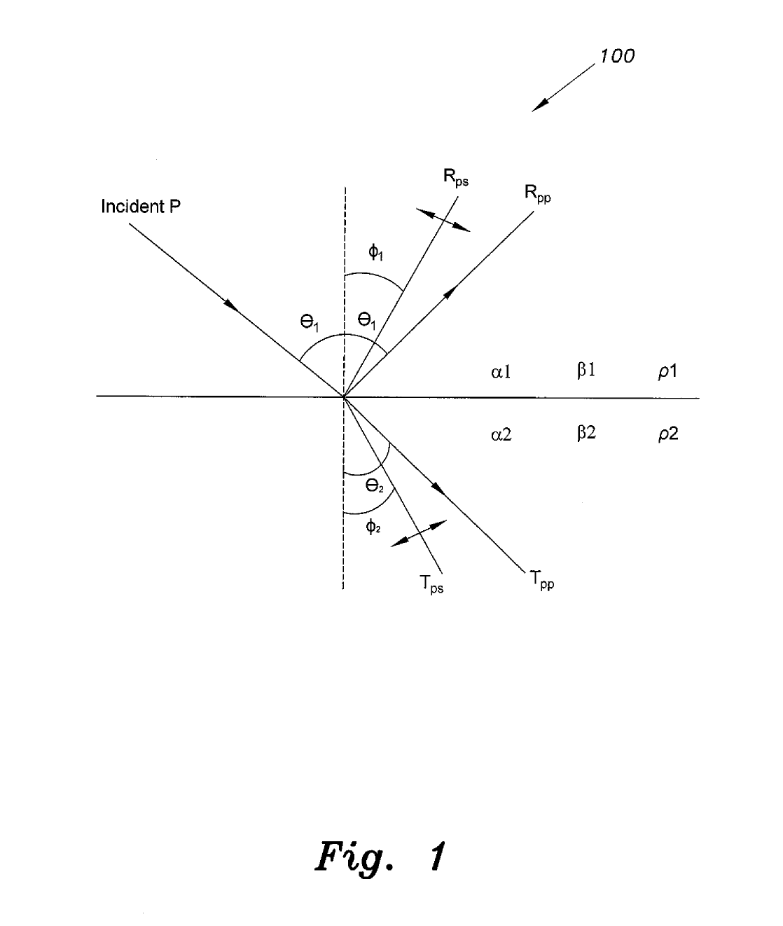

In particular, the present transmission coefficient method expresses the approximate Aki-Richards formulas for the incident-P-to-transmitted-P (T_{PP}) and incident-P-to-transmitted-S (T_{PS}) in a form that is more convenient to AVO analysis to facilitate the use of existing AVO methods and software codes. FIG. 1 shows the various wave modes generated at an interface by an incident P-wave. Over the years emphasis has been on reflected modes due to an incident P-wave (i.e., R_{PP} and R_{PS}) for the purpose of AVO studies. The present method focuses on the transmitted modes (i.e., T_{PP} and T_{PS}).

The transmission coefficient method for AVO seismic analysis provides AVO analysis on the transmission coefficients of VSP data. Amplitude variation with offset (AVO) computation techniques known in the art provide estimates of pressure wave, shear wave and pseudo-Poisson's reflectivity. All of these estimates are based on the Aki-Richards approximation of Zoeppritz's formulation of reflection amplitude and polarity variation with respect to incidence angle. The Aid-Richards approximation assumes that interfaces have gentle impedance contrast. The Zoeppritz equations describe the amplitudes of body waves when incident on an interface, resulting in a scattering matrix in which all possible incident and generated modes are addressed. Due to the complexities in the expression of the individual components of the scattering matrix, Aki and Richards expressed these equations in a simplified form assuming small material contrasts and precritical angles.

The approximate Aki-Richards expressions for the incident Pressure wave (P) to-transmitted pressure wave (P) amplitude, T_{PP}, and incident Pressure wave (P) to-transmitted shear wave (S) amplitude, T_{PS}, are:

$$\begin{matrix}{T}_{PP} = 1 - \frac{1}{2} \frac{Δ ρ}{ρ} + ( \frac{1}{2 {Cos}^{2} [ θ ]} - 1 ) \frac{Δ α}{α} and & ( 1 ) \\ {T}_{PS} = \frac{p α}{2 Cos [ φ ]} [ \begin{matrix}( 1 - 2 {β}^{2} {p}^{2} - 2 {β}^{2} \frac{Cos [ θ ]}{α} \frac{\\ Cos [ φ ]}{β} ) \frac{Δ ρ}{ρ} - \\ 4 {β}^{2} ( {p}^{2} + \frac{Cos [ θ ]}{α} \frac{Cos [ φ ]}{β} ) \frac{Δ β}{β}\end{matrix} ] & ( 2 )\end{matrix}$$

The variable p in equation (2) is the ray parameter, given as:

$$p = \frac{Sin [ θ ]}{α} = \frac{Sin [ φ ]}{β} \qquad ( 3 )$$

Starting with equation (1), T_{PP} can be expressed in terms of the incident angle θ after appropriate trigonometric manipulations as:

$${T}_{PP} ( θ ) = ( 1 - \frac{Δ ρ}{2 ρ} - \frac{Δ α}{2 α} ) + \frac{Δ α}{2 α} {Tan}^{2} [ θ ] \qquad ( 4 )$$

which can be put in the following AVO-convenient form:

$${T}_{PP} ( θ ) = A + B {Tan}^{2} [ θ ] \\ where \\ A = 1 - ( \frac{Δ ρ}{2 ρ} + \frac{Δ α}{2 α} ) = 1 - {R}_{PP 0} = {T}_{PP 0} , B = \frac{Δ α}{2 α} , \qquad ( 5 )$$

and R_{PP0} and T_{PP0} are the zero-offset PP-reflection and transmission coefficients, respectively. Terms involving the angle φ in equation (2) can be expressed in terms of the angle θ as:

$$\begin{matrix}Sin [ φ ] = \frac{β}{α} Sin [ θ ] , and & ( 6 ) \\ Cos [ φ ] = \sqrt{1 - {( \frac{β}{α} )}^{2} {Sin}^{2} [ θ ]} & ( 7 )\end{matrix}$$

Next, we expand the square root in equation (7) in a Maclaurin's series and truncate it at the third term:

$$Cos [ φ ] ≅ 1 - \frac{{β}^{2} {Sin}^{2} [ θ ]}{2 {α}^{2}} - \frac{{β}^{4} {Sin}^{4} [ θ ]}{8 {α}^{4}} \qquad ( 8 )$$

We also use the following expansion:

$$\frac{1}{Cos [ φ ]} ≅ 1 + \frac{{β}^{2} {Sin}^{2} [ θ ]}{2 {α}^{2}} + \frac{3 {β}^{4} {Sin}^{4} [ θ ]}{8 {α}^{4}} \qquad ( 9 )$$

Substituting equations (6), (7), and (8) into equation (2) and collecting similar powers of Sin[θ] yield this expansion:

$${T}_{PS} ( θ ) = ( - \frac{β}{α} ( \frac{Δ ρ}{ρ} + \frac{2 Δ β}{β} ) + \frac{1}{2} \frac{Δ ρ}{ρ} ) Sin [ θ ] + ( \frac{β}{α} ( ( \frac{Δ β}{β} + \frac{Δ ρ}{2 ρ} ) - \frac{β}{α} ( \frac{2 Δ β}{β} + \frac{Δ ρ}{4 ρ} ) ) ) {Sin}^{3} [ θ ] + ( - {( \frac{β}{α} )}^{4} ( \frac{Δ β}{β} + \frac{Δ ρ}{8 ρ} ) ) {Sin}^{5} [ θ ] , \qquad ( 10 )$$

which can be put in the following AVO-convenient form:

$${T}_{PS} ( θ ) = A Sin [ θ ] + B {Sin}^{3} [ θ ] + C {Sin}^{5} [ θ ] where \\ A = - \frac{β}{α} ( \frac{Δ ρ}{ρ} + \frac{2 Δ β}{β} ) + \frac{1}{2} \frac{Δ ρ}{ρ} , \\ B = \frac{β}{α} ( ( \frac{Δ β}{β} + \frac{Δ ρ}{2 ρ} ) - \frac{β}{α} ( \frac{2 Δ β}{β} + \frac{Δ ρ}{4 ρ} ) ) , and \\ C = - {( \frac{β}{α} )}^{4} ( \frac{Δ β}{β} + \frac{Δ ρ}{8 ρ} ) . \qquad ( 11 )$$

In all of the above expressions, α, β, and ρ indicate the average value, while Δα, Δβ, and Δρ indicate the difference across the interface.

Equation (4) shows that T_{PP} is sensitive to P-wave and density changes and does not depend on S-wave changes. T_{PS}, on the other hand, is insensitive to changes in P-wave, as could be observed in equation (10). To test the performance of the derived approximations, we use the typical parameters of an oil sand model shown in Table 1.

TABLE 1
Parameter values

| Layer 1 | | | Layer 2 | | |
|---|---|---|---|---|---|
| α1 (m/s) | β1 (m/s) | ρ1 (g/cc) | α2 (m/s) | β2 (m/s) | ρ2 (g/cc) |
| 3170 | 1668 | 2.36 | 3734 | 2280 | 2.27 |

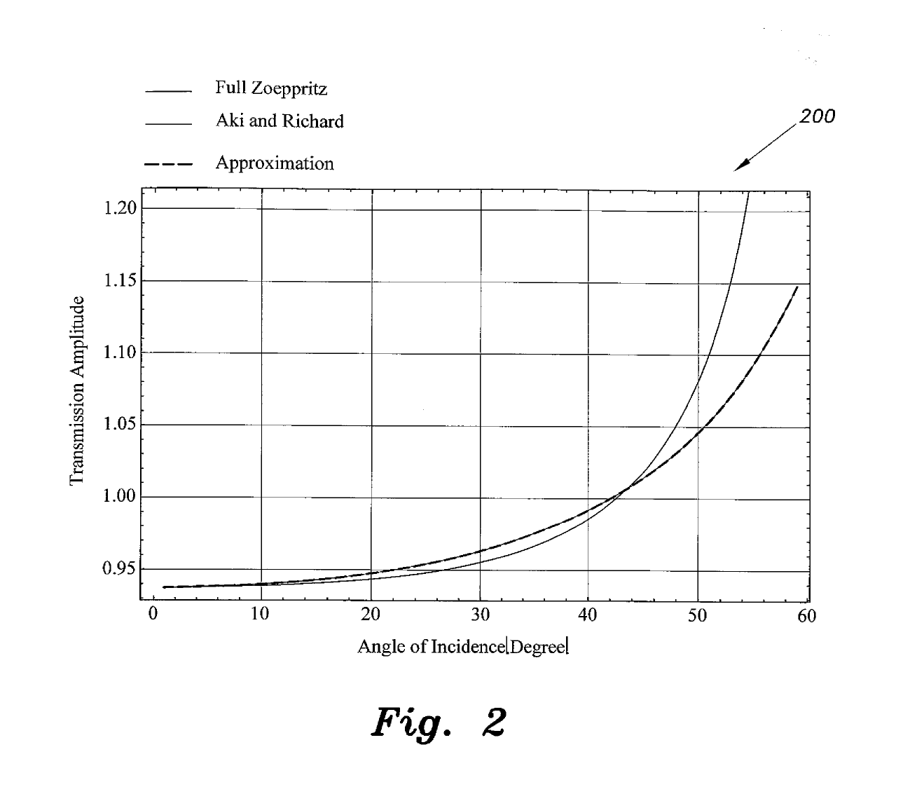

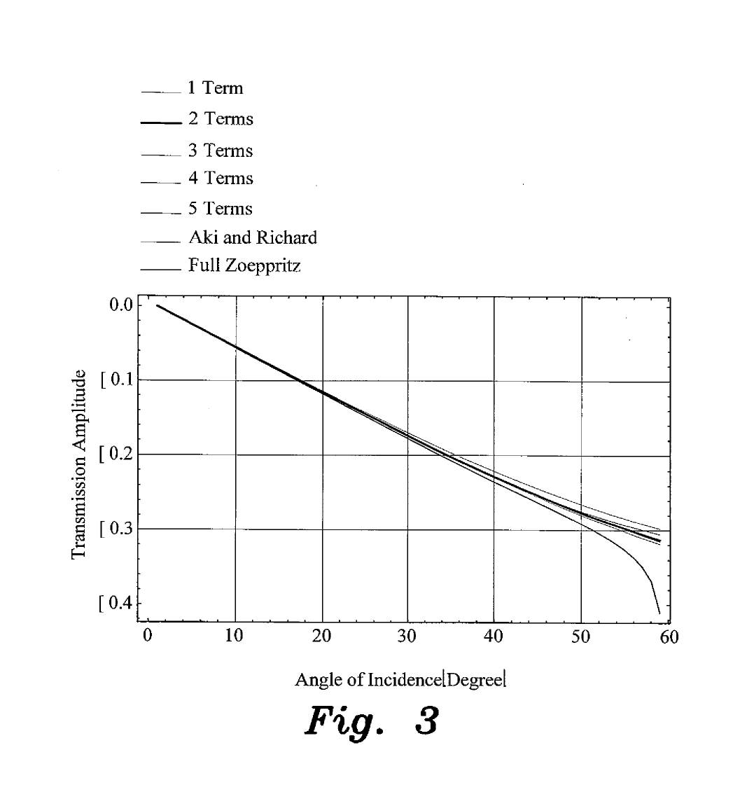

Plot 200 of FIG. 2 shows that the T_{PP} approximation of the present method is always within 7% error from the exact Zoeppritz equation up to an incidence angle of 90% of the critical angle (58° for this model). FIG. 3 shows plots 300 of the present T_{PS} approximation with increasing number of terms compared to the exact Zoeppritz equation. This figure shows that fitting 1-term and 2-term approximations produced errors of less than 10% and 6%, respectively, from the exact Zoeppritz equation up to an incidence angle of 90% of the critical angle. FIG. 3 also shows that adding more terms did not decrease the error between the T_{PS} approximation and the exact Zoeppritz equation. Testing two other models showed similar results. Therefore, we conclude that the 2-term T_{PS} approximation produced the best compromise in terms of the least number of terms with the least error from the exact Zoeppritz equation up to an incidence angle of 90% of the critical angle.

In summary, the present method derives AVO-like approximate expressions for the transmission coefficients of the PP and PS modes. Modeling results indicated that the derived T_{PP} approximation does not depend on S-wave changes; The derived 1-term T_{PS} approximation is good up to intermediate incidence angles. Two or 3-term approximations might be needed for larger angles (i.e., up to 10% of critical angle). Including more terms than three does not improve the results. Density has the largest impact on T_{PS} and its impact increases with increasing number of terms. The second effective parameter on T_{PS} is the S-wave velocity, while P-wave velocity has the least effect on T_{PS}.

It is to be understood that the present invention is not limited to the embodiments described above, but encompasses any and all embodiments within the scope of the following claims.

We claim:

1. A computer-implemented transmission coefficient method for AVO (amplitude variation with offset) seismic analysis, comprising the steps of:
computing incident Pressure wave (P) to-transmitted pressure wave (P) amplitude (T_{PP}) according to the relation:
T_{PP}(θ)=A+B Tan²[θ];
computing incident Pressure wave (P) to-transmitted shear wave (S) amplitude (T_{PS}) according to the relation:
T_{PS}(θ)=A Sin[θ]+B Sin³[θ]+C Sin⁵[θ],
the computing steps being performed by a computer; and
storing the computed T_{PP}(θ) and the computed T_{PS}(θ) on digital storage media readable by a computer for use by an AVO-compatible software application.

2. The computer-implemented transmission coefficient method for AVO seismic analysis according to claim 1, further comprising the step of:
adding terms to the (T_{PS}) relation by performing a Maclaurin's series expansion of
$$Cos [ φ ] = \sqrt{1 - {( \frac{β}{α} )}^{2} {Sin}^{2} [ θ ]}$$
out to N terms; and
using the expansion to form a T_{PS}(θ) equation characterized by the relation:
T_{PS}(θ)=A Sin[θ]+B Sin³[θ]+C Sin⁵[θ]+D Sin⁷[θ]+E Sin⁹[θ]+ . . . Z Sin^{N+(N-1)}[θ],
the adding terms and using the expansion steps being performed by the computer.

3. A computer software product, comprising a non-transitory medium readable by a processor, the non-transitory medium having stored thereon a set of instructions for performing a transmission coefficient method for AVO (amplitude variation with offset) seismic analysis, the set of instructions including:
(a) a first sequence of instructions which, when executed by the processor, causes said processor to compute incident Pressure wave (P) to-transmitted pressure wave (P) amplitude (T_{PP}) according to the relation:
T_{PP}(θ)=A+B Tan²[θ];
(b) a second sequence of instructions which, when executed by the processor, causes said processor to compute incident Pressure wave (P) to-transmitted shear wave (S) amplitude (T_{PS}) according to the relation:
T_{PS}(θ)=A Sin[θ]+B Sin³[θ]+C Sin⁵[θ];
(c) a third sequence of instructions which, when executed by the processor, causes said processor to store the computed T_{PP}(θ) and the computed T_{PS}(θ) on digital storage media readable by a computer for use by an AVO-compatible software application.

4. The computer software product according to claim 3, further comprising:
a fourth sequence of instructions which, when executed by the processor, causes said processor to add terms to the (T_{PS}) relation by performing a Maclaurin's series expansion of
$$Cos [ φ ] = \sqrt{1 - {( \frac{β}{α} )}^{2} {Sin}^{2} [ θ ]}$$
out to N terms, and using said expansion to form a T_{PS}(θ) equation characterized by the relation:
T_{PS}(θ)=A Sin[θ]+B Sin³[θ]+C Sin⁵[θ]+D Sin⁷[θ]+E Sin⁹[θ]+ . . . Z Sin^{N+(N-1)}[θ].
